(19) United States
(12) Patent Application Publication
(10) Pub. No.: US 2007/0162288 A1
(43) Pub. Date: Jul. 12, 2007

(54) Method for automatically generating a spare parts list

(75) Inventors: Thorsten Springhart, Freiburg (DE); Thomas Fricke, Nesselwang (DE); Norbert Steck, Bollen (DE); Didier Heyer, Pfetterhouse (FR); Markus Rauch, Reinach (CH); Inge Hess, Maulburg (DE); Thomas Schindler, Schopfheim (DE)

Correspondence Address: BACON & THOMAS, PLLC, 625 SLATERS LANE, FOURTH FLOOR, ALEXANDRIA, VA, 22314, US

(73) Assignee: Endress + Hauser (DE) Holding Gmhb, Weil am Rhein (DE)

(21) Appl. No.: 10/556,810

(22) PCT Filed: May 4, 2004
(86) PCT No.: PCT/EP04/04696

§ 371 Date: Dec. 22, 2006

(30) Foreign Application Priority Data
May 15, 2003 (DE) 10322080.1

(51) Int. Cl. G06Q 99/00

(52) U.S. Cl. 705/1

(57) ABSTRACT

A method for automatic creation of a spare part list for a product having a predetermined order code formed from a plurality of feature fields M1, M2, M3, etc. having corresponding attributes characterizing the product spare part codes of individual spare parts being stored in a file, which spare part codes correspond to the order codes of the product for which a respective spare part is suited. An order code is electronically input and those parts are automatically displayed on a computer unit, whose attributes agree with the attributes of the order code.

The invention relates to a method for automatically producing a spare part list, as such method is defined in the preamble of claim 1.

In process automation technology, field devices are applied in a wide variety of applications for registering and/or influencing process variables. Examples for such field devices are fill-level measuring devices, mass flow measuring devices, pressure- and temperature-measuring devices, pH-redox-potential measuring devices, conductivity measuring devices, etc., which, as sensors, register the corresponding process variables fill-level, flow, e.g. flow rate, pressure, temperature, pH-value, and conductivity.

Besides such measuring devices, systems are also known, which fulfill other tasks, along with the registering of the variables to be measured; to be mentioned here are electrode cleaning systems, calibration systems, and sample takers.

Also falling under the field-device label are input/output units, so-called remote I/Os.

Serving for the influencing of process variables are so-called actuators, e.g. valves, which control the flow of a liquid in a section of pipeline, or pumps, which influence fill level in a container.

A large number of such field devices are manufactured and sold by the firm, Endress+Hauser®.

Frequently, field devices in a modern fabrication plant are connected via a fieldbus (Profibus®, Foundation®-fieldbus, HART®, etc.) with superordinated units, e.g. control systems, or units. Such superordinated units serve for process control, process visualization, process monitoring, as well as for the operating and monitoring of field devices.

A significant cost factor in the case of modern fabrication plants is that of maintenance. Spare parts for the field devices must be kept available in stock, in order to be able to react quickly in the case of a malfunction of a field device. The failure of a single field device at a strategically important point in the process can lead to the shutdown of an entire production plant. For this reason, the firm Endress+Hauser® offers a service package IMS (Instrument Management Solution), which provides for studying a production plant with reference to the development of an optimized plan of maintenance for increased plant reliability.

For an operator of a plant, it is, among other things, important to know, which spare parts are needed for which field devices and whether spare parts present in stock are really still usable.

To this point in time, it has been customary to make available to the plant operator, in paper form, spare part lists for field devices.

As a rule, for any given field device, a variety of application-specific variants exist, which can differ considerably as regards spare parts. For the plant operator, therefore, the subject of finding the right spare part list is quite complicated.

Likewise for the device manufacturer, it is extremely involved to produce appropriate spare part lists of all variants of its devices.

Frequently in a fabrication plant, equal, or similar, field devices are applied. Keeping all spare parts for each of these devices would be associated with considerable inventory costs.

An object of the present invention is to provide a method for automatic production of a spare part list. The method avoids the above-mentioned disadvantages and can be performed very simply and cost-favorably.

This object is attained by the method defined in claim 1.

An essential idea of the invention is to generate a spare part list for a product through use of the order code of the product. To this end, spare part codes for the individual spare parts are stored in a file. The order code is composed of a plurality of feature fields with corresponding attributes, which characterize the product.

After input of an order code, those spare parts are automatically displayed in a computing unit, whose attributes agree with the attributes of the order code.

In order not to have to produce unnecessarily many spare part codes, a further development of the invention provides that feature fields remain empty, when a spare part is appropriate for all attributes of these feature fields.

Creating the spare part codes is simplified according to a further development of the invention by first producing a list with all features for each of the feature fields of a product group and then a list of all spare parts pertinent for this product group is produced. From these two lists, a matrix is produced, in which the possible combinations of features and spare parts are marked. The spare part codes can be obtained simply from this matrix.

In a further development of the invention, the list with all features for a product is obtained from an SAP®-application. The list of the spare parts can likewise be produced in simple manner from an available price list.

Often, a plant operator would like to have available a spare part list for a plurality of field devices. In a further development of the invention, it is therefore possible to input a plurality of order codes electronically together. The spare part list is then matched to a plurality of products.

At times, a plant operator already knows, from an Instrument-Management-System IMS (e.g. IBA Installed Base Analyst of the firm Endress+Hauser®), the order codes of the field devices, which it is using.

The method of the invention is especially suited for field devices of process automation technology.

In order to be able always to make available for the plant operator an up-to-date list of the required spare parts, the method is implemented as an Internet application on a server of the device manufacturer.

The invention will now be explained in greater detail on the basis of an example of an embodiment shown in the drawing, the figures of which show as follows:

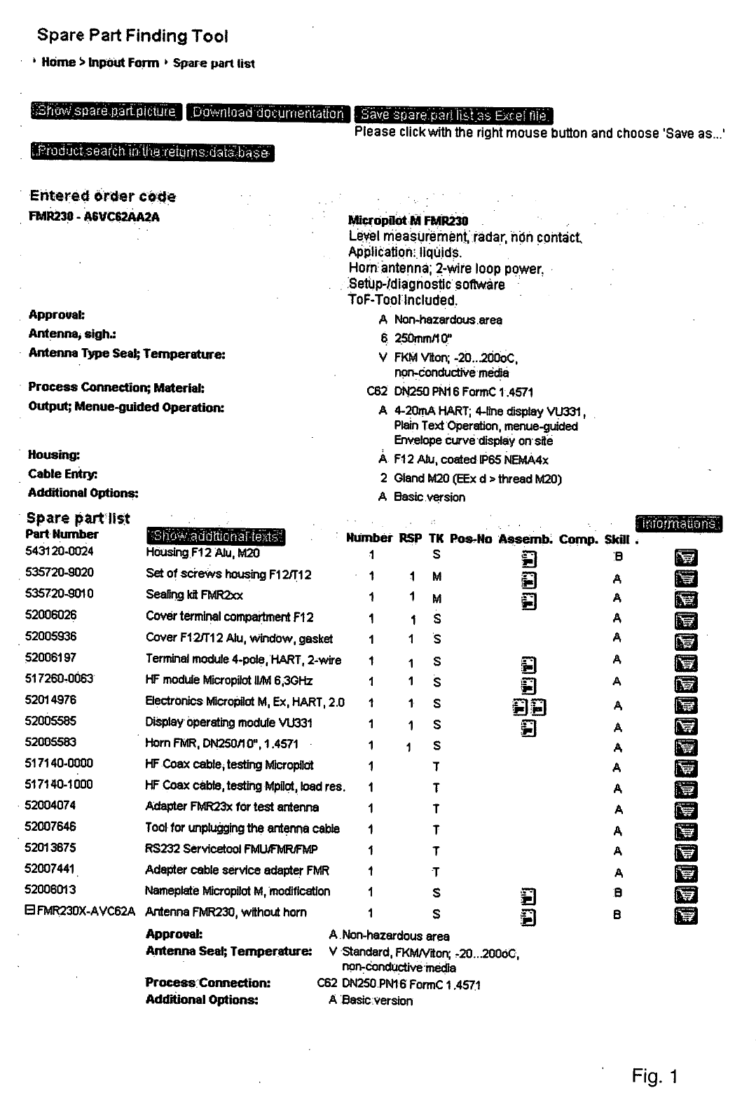

FIG. 1 illustration of a spare part list obtained via an order code;

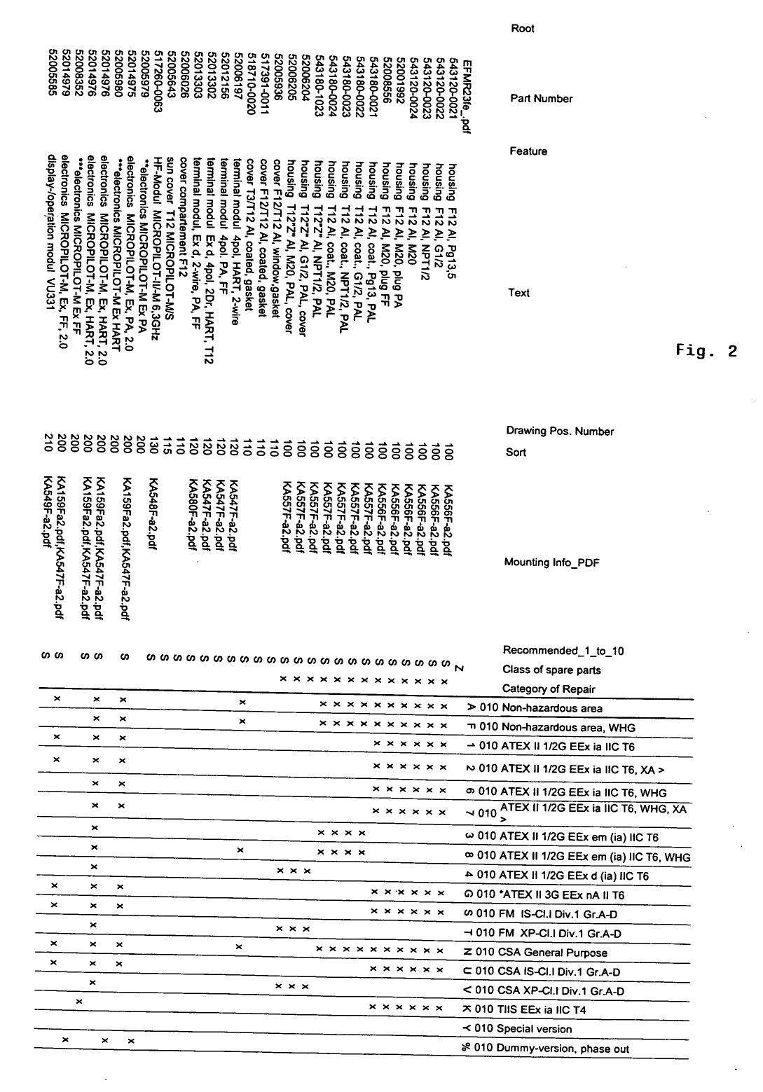

FIG. 2 schematic illustration of a matrix having different features and a plurality of spare parts for a product group; and

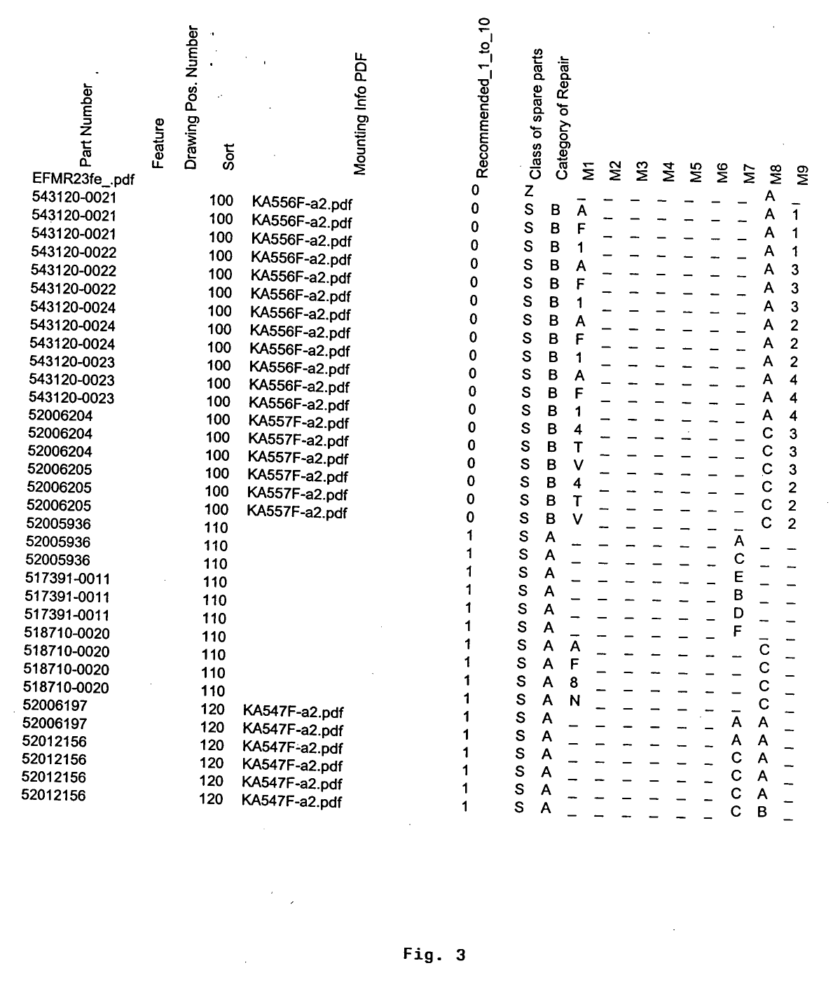

FIG. 3 list of spare part codes.

For producing the spare part list shown in FIG. 1, the following order code was input: FMR230-A6VC62AA2A. This order code is composed of a root, FMR230, which identifies the product group, in this case Micropilot M of the firm Endress+Hauser®. The order code has eight feature fields M1, M2, . . . M8, which more closely specify the variants of the field device. In feature field M1 (Approval), attribute A is entered, which specifies the variant for non-hazardous areas. In feature field M2, which defines the antenna size, the attribute 6 is entered, which identifies a 250 mm/10″I-antenna. In feature field M3 (antenna type, sealing, temperature), the attribute V is inserted, which characterizes use of the field device in non-conductive media. The attribute C62 in feature field M4 describes the process connection and the material used. The other features M5 to M8 are not discussed further, since they are self-explanatory for those skilled in the art.

Displayed as spare part list is a list composed of part number, designation and other additional information matched to the device characterized by the above-designated order code. “Rsp.” means “recommended spare pare”, i.e. this spare part is recommended by the manufacturer as one to keep in stock. Under “Assemb.”, instructions for installation can be called up. Via a corresponding button (stylized shopping cart), the spare part can be placed in a “shopping cart” and then subsequently electronically ordered. A connection to an eShop is thus present. The application, in which the method of the invention is executable in a computing unit, can also be easily integrated into a Life Cycle Management application, e.g. W@M® of the firm Endress+Hauser®.

All spare parts belonging to a product group are displayed, when the root FMR230 is input.

FIG. 2 shows a matrix composed of a list with all features for a product group and a list with all available spare parts. In this list, the valid combinations of features and spare parts are marked with an x. The placing of the marks requires no special qualifications and thus can also be performed simply and reliably by employees who are not specially trained.

For each product group of the device manufacturer, such a matrix is created and a corresponding list with part numbers and belonging spare part codes produced.

As shown in FIG. 3, belonging to the spare part with the part number 518710-0022 are four different spare part codes, which differ only in the feature M1. Besides the spare part codes, additional information is displayed for the spare parts, information such as e.g. name of the file with the associated instructions for installation.

The method of the invention will now be explained in greater detail. The user starts a corresponding application (Spare Part Finding Tool) in a computing unit. The application requests the user to input an appropriate order code. Following input of the order code, the attributes of the order code are compared with the attributes in a file of stored spare part codes and those spare parts are automatically displayed on the computing unit, the attributes of which spare parts agree with the attributes of the order code.

As explained in the description for FIG. 3, the spare part codes are obtained in simple manner by producing a matrix of all features and all spare parts for a product group, and, in this matrix, the valid combinations of features and spare parts are marked.

In order not to have to create anew by hand a list with all features for a product, this list can be obtained from an SAP-application available, as a rule, to the device manufacturer. In simple manner, the list of spare parts is obtained from an available price list.

1-10. (canceled)

11. A method for automatic creation of a spare part list for a product, comprising the steps of:
providing a predetermined order code formed from a plurality of feature fields M1, M2, M3, etc. having corresponding attributes characterizing the product:
storing spare codes for individual spare parts in a file, which spare part codes correspond to the order codes of the products, for which a respective spare part is suited; and
electronically inputting an order code and those spare parts are automatically displayed on a computing unit, whose attributes agree with the attributes of the order code.

12. The method as claimed in claim 11, wherein: when a spare part matches all attributes of a feature field, such feature field is left empty.

13. The method as claimed in claim 11, wherein the spare part codes are obtained as follows:
creating a list with all features for the individual feature fields of a product group;
creating a list of all spare parts available for said product group; and
creating a matrix from these two lists, in which matrix the valid combinations of features and spare parts are marked and producing the spare part codes from this matrix.

14. The method as claimed in claim 13, wherein:
the list with all features for a product group is obtained from an SAP application.

15. The method as claimed in claim 13, wherein the list of spare parts is obtained from an available price list.

16. The method as claimed in claim 11, wherein a common spare part list is created for a plurality of products having different order codes.

17. The method as claimed in claim 11, wherein the order codes are obtained from an IBA-(lnstalled Base Analyst)-application.

18. The method as claimed in claim 11, wherein the product is a device of process automation technology.

19. The method as claimed in claim 11, wherein the method is implemented as an Internet application.

20. The method as claimed in claim 11, wherein the belonging product is displayed for the part number of a spare part.
